(19) United States
(12) Patent Application Publication
(10) Pub. No.: US 2008/0164635 A1
(43) Pub. Date: Jul. 10, 2008

(54) Method for making multi-finish thermoplastic articles

(76) Inventor: Thomas H. Werner, Muehltal (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/002,956

(22) Filed: Dec. 19, 2007

Related U.S. Application Data
(60) Provisional application No. 60/876,973, filed on Dec. 22, 2006.

(51) Int. Cl. B28B 7/22

(52) U.S. Cl. 264/255

(57) ABSTRACT

The invention provides a method for producing thermoplastic articles of two or more components with different surface finishes on different surface zones, using overmolding. In particular, a method is provided for producing thermoplastic articles of two or more components with a different surface finish on different surface zones, wherein one component has a paint finish.

### CROSS-REFERENCE TO RELATED APPLICATION

This application claims the benefit of U.S. Provisional Application No. 60/876,973, filed Dec. 22, 2006, which is incorporated by reference herein in its entirety.

### BACKGROUND OF THE INVENTION

1. Field of the Invention

This invention relates to a method for producing thermoplastic articles of two or more components with different surface finishes, and final products resulting therefrom. In particular, the invention provides a method for producing thermoplastic articles of two or more components having different surface finishes, wherein one component comprises a paint finish.

2. Description of Related Art

Components for machinery, e.g. parts for motor vehicles, packaging of electronic components as well as other technical items such as switch covers, buttons, knobs and inserts, are increasingly made of thermoplastic material.

For aesthetic reasons, it is often desired to impart different surface colors or finishes to different surface areas of a thermoplastic molded article, such as for example a glossy paint finish on some parts and a matte finish on other parts. This is conventionally done by several methods: 1) Masking: parts of the molded article are masked with a covering material (e.g. adhesive tape) and the unmasked parts are painted, for example with spray paint or powder coating, followed by unmasking; 2) Assembly: a finished article may be made in separate parts, the separate parts painted or finished in the desired way, and then the separate parts assembled and glued together.

Masking suffers the drawback of being time consuming and expensive to implement as it requires manual manipulation. The painted part must subsequently be unmasked, again requiring manual manipulation. Colour and finish choices are limited by the method which practically permits only two colors or finishes. This method has the further drawback that the masking of some of the parts of the article may alter the appearance of the final product, for example by leaving traces of adhesive. It also leads to irregular painting contours due to poor reproducibility of the masking.

The assembly method is also expensive to implement, since the final article must be assembled from its components and glued together. Adhesive strength or aging resistance is often not sufficient and may compromise the integrity of the finished article. In addition, if the finished article is to be in contact with food, beverages, cosmetics or pharmaceuticals, not only must the thermoplastic be approved by heath authorities but also the glue itself.

Techniques that have been developed for providing articles exhibiting a combination of properties consist in simultaneously injecting dissimilar starting materials into the same mold, at predetermined positions therein, for example as described in U.S. Pat. No. 3,950,483. These techniques are injection molding processes and are therefore not adapted to the manufacture of multi-component articles with the desired various finishes of most thermoplastic materials used in the machinery industry. For example, these injection molding techniques are not applicable to the manufacture of multi-component thermoplastic articles wherein at least one component has a metallic finish (e.g. silver, chrome, steel or aluminium), a glossy or a mirror-like finish of a paint, because injection molding leads to articles with a matte aspect. Further, these injection techniques are generally not adapted to more than two component articles. For highly demanding aesthetic applications such as automotive parts or packaging of electronic components, injection molding processes with in situ light coloured plastics are not suitable as the final aspect of the article would be too sensitive to colour shifts induced for example by temperature, chemical attack or light exposure.

The technique of “Overmolding” (2-K Molding) offers various advantages for making articles having two or more thermoplastic components, including avoiding the gluing step in the assembly of the thermoplastic articles of two or more components. It is widely used by suppliers to the automotive and electronic component industries to manufacture a variety of articles, from small articles such as bottle caps to entire body panels of cars, and furniture.

However, when production of thermoplastic articles comprising two or more components is performed by overmolding, masking steps are again necessary to obtain a multiple finish aspect.

Therefore, new methods for the simple, cost-effective creation of molded articles, having at least two different surface colors and/or finishes are required, particularly for automobiles, electronic household appliances, engineered packaging and devices in the healthcare industry.

a. “Injection Molding”

Injection molding is a manufacturing technique for making parts from plastic material. Molten plastic is injected under pressure into a mold having a cavity of the desired shape.

Advantages of injection molding include the fact that almost all thermoplastic materials can be formed, large and small parts can be produced, automation of the process permits high output rates, and low labour costs. Injection molding is suitable for mass production.

b. “Overmolding”

“Overmolding” also called “2K-molding” or “multi-component injection molding process” is an injection molding technique that is described in Hagen et al, Kunstoffe, 1989, 79, 72-76 for the manufacture of frames for glasses. The overmolding process consists in a process wherein a first part of a molded article is injection molded (often with a first polymer) and a second part is “overmolded” to the first part by injecting additional polymer (which may be the same polymer or a different polymer). Good adhesion between the two parts usually results, due to thermal bonding or chemical bonding, or a combination.

Overmolding is also known as “multishot injection molding” and “in-mold assembly” process.

The overmolding technique leads to various downstream benefits including reduced cost and lead time for tooling, easier assembly of snap-together parts, better surface finish, improved packing density, greater scuff and scratch resistance, soft touch and functional ruggedness. One of the most popular applications is the overmolding of a flexible thermoplastic elastomer (TPE) onto a rigid substrate to create a soft-touch feel and improved handling in a finished product. Overmolded articles have not only better mechanical characteristics (e.g. durability and mechanical resistance to shock and vibration) but also functional (e.g. environmental sealing of circuitry), tactile (e.g. soft touch on the outside, a smooth surface on the inside) over classically molded and assembled articles.

Overmolding may be carried out using a single mold. In this case, stops are placed in the mold to prevent it being filled entirely with the first polymer, and the first polymer is injected through gates located in the part of the mold it is desired to fill. After injection of the first polymer, the stops are removed, and the second polymer is injected through gates located in the unfilled part of the mold. This kind of Overmolding is called “two-shot injection”.

Alternatively, a first part may be injection molded, the part removed from the mold and placed in a second mold, designed to contain the first part and have a cavity suitable for molding the second part, and the second polymer is injection molded to fill the cavity.

### SUMMARY OF THE INVENTION

The invention provides a method for producing thermoplastic articles of two or more components with different surface finishes in different surface zones, using a step of overmolding, thus avoiding masking and assembly.

In particular, the method according to the invention comprises the following steps:
(1) injection molding a first thermoplastic part of the article;
(2) applying a surface finish to the first part;
(3) placing the first part in an injection molding mold;
(4) overmolding a second thermoplastic part of the article in such a way as to form an interface between the first part and the second part, where adhesion between the first part and the second part is achieved at the interface.

The invention also provides thermoplastic articles of two or more components with different surface finishes on different surface zones, produced by the method according to the invention.

### BRIEF DESCRIPTION OF THE DRAWINGS

In the accompanying drawings is shown various illustrative embodiments of the inventions:

FIG. 1 shows a car air intake manifold with a runner and its cover that can be obtained by the process according to the invention. The first part is the cover, which has a metallic finish. This has been overmolded with the second part, the runner base. The runner base is coloured with carbon black included in the resin.

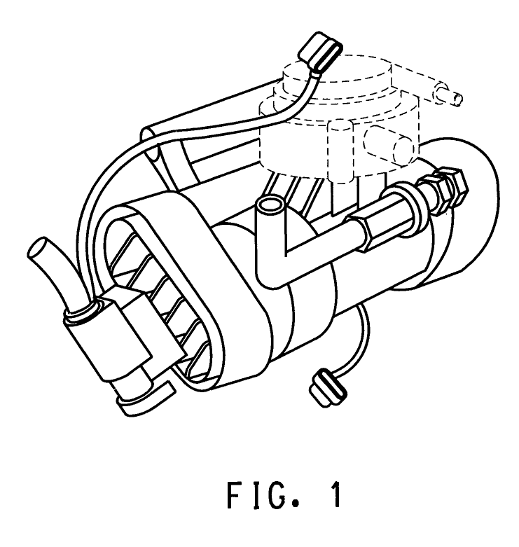

### DETAILED DESCRIPTION OF THE INVENTION

The invention provides a method for producing thermoplastic articles of two or more components with different surface finishes in different surface zones, using overmolding.

According to one aspect of the invention, is provided a method comprising the following steps:
(1) injection molding a first thermoplastic part of the article;
(2) applying a surface finish to the first part;
(3) placing the first part in an injection molding mold;
(4) overmolding a second thermoplastic part of the article in such a way as to form an interface between the first part and the second part, wherein adhesion between the first part and the second part is achieved at the interface.

According to a further aspect of the invention, is provided a method according to the invention wherein injection molding of said first thermoplastic part of the article comprises the steps of:
(a) selecting a first thermoplastic resin;
(b) melting the first thermoplastic resin;
(c) injection molding of the first thermoplastic resin; and
(d) cooling the injection molded resin to crystallize the first thermoplastic resin.

In a preferred embodiment, said first thermoplastic resin is selected from Styrenic polymers, Polycarbonates, Polypthalamides, Polyterephthalates, thermoplastic polyesters, Thermoplastic Elastomers (copolyetheresters) Polyamides, and blends of these resins, including blends with other resins.

In a further preferred embodiment, said first thermoplastic resin is selected from Polyamides and Polypthalamides, both of which are preferably glass reinforced.

According to a further preferred embodiment, the first thermoplastic is selected from polyamide 66, polyamide 6, preferably with 30 wt % glass fiber, and polyamide 66, preferably with 35 wt % glass fiber.

More preferably, said first thermoplastic resin is selected from PA 6 GF 30, PA 66 GF 35 and PPA GF (e.g. ZYTEL® 73G30 HSL BK416 (30% glass fiber reinforced, heat stabilized, black polyamide 6 resin), ZYTEL® 70G35 HSLRA4 BK267 (35% glass fiber reinforced, heat stabilized, hydrolysis resistant polyamide 66 resin), ZYTEL® HTN51G35 HSLR BK420 (35% glass reinforced, heat stabilized, lubricated high performance polyamide resin), and ZYTEL® 77G33 L BK (33% glass fiber reinforced, black polyamide 612 resin)).

Preferably the cooling of the injection molded first resin to crystallize is achieved, for example, by blowing filtered air, using vacuum ovens or rotary vacuum tumbler dryers. Preferably the water content of the drying air is low: a dew point of −18° C. or less is recommended. The drying temperature reduces the drying time but should not be too high in order to preserve the thermoplastic integrity.

Advantageously the finish applied to the surface of the first thermoplastic part is applied by a technique selected from painting, vapor deposition, electroplating, powder coating and air spray painting, more preferably powder coating and air spray painting.

Advantageously the finish applied to the surface of the first thermoplastic part is a high-temperature resistant paint.

In another embodiment, the finish applied to the surface of the first thermoplastic part is a metallic finish, applied by painting, vacuum deposition or electroplating.

According to a further preferred embodiment, after the finish is applied to the surface of the first thermoplastic, the part is subjected to a drying step, preferably at room temperature.

The surface area of the first thermoplastic part which will be in contact with the second resin can be called the interface area. Preferably the finish is not applied over more than at or about 60% of the interface area of the first thermoplastic part, more preferably not more than at or about 40%, particularly preferably not more than at or about 25%. In this way good adhesion between the first and second thermoplastic parts is ensured.

Preferably the first finished thermoplastic part is held in place in the mold for the second thermoplastic part during overmolding of the second part.

According to a preferred embodiment, the overmolding of said second thermoplastic part of the article comprises the steps of:
(a′) selecting a second thermoplastic resin;
(b′) optionally adding a compatibilising agent to the second thermoplastic resin selected under (a′);
(c′) melting the second thermoplastic resin; and
(d′) overmolding of the heated second thermoplastic resin to the first thermoplastic part.

According to a further preferred embodiment the overmolding of said second thermoplastic part of the article comprises the step of selecting a second thermoplastic resin from Styrenic polymers, Polycarbonates, Polyphthalamides, Polyterephthalates, thermoplastic polyesters, Thermoplastic Elastomer-Ether-Esters and Polyamides.

The first and second thermoplastic may be the same or different.

According to a further preferred embodiment the second thermoplastic is selected from polyamide 66, polyamide 6, preferably with 30 wt % glass fiber, and polyamide 66, preferably with 35 wt % glass fiber.

In a preferred embodiment, the thermoplastic resin for the second part is carbon black coloured. This results in an attractive contrast with the first part when, for example, a metallic finish is used for the first part.

The invention also provides a thermoplastic article of two or more components with different surface finishes in different surface zones, produced by the method of the invention.

In a preferred embodiment, at least one component comprises a paint finish such as a painted metallic finish, or a metallic finish applied by vacuum deposition, or a metallic finish applied by etching and plating.

In a preferred embodiment the article is an automobile part having two or more components, for example, an air intake module, a door handle, a tool, a gasket, a seal, a hose, a bumper, electrical boots, with a different surface finish produced by the method according to the invention, wherein at least one component comprises a paint finish such as a painted metallic finish.

### 2. Abbreviations

The following abbreviations are used in the description and claims: ABS: Acrylonitrile Butadiene Styrene; ASA: acrylic styrene acrylonitrile; EVA: ethylene vinylacetate copolymer; GF: glass fiber; PBT: Polybutylene terephthalate; PC: polycarbonate; PET, PETE, PETP: Polyethylene terephthalate; PPA: Polyphthalamide; TEEE: Thermoplastic Elastomer-Ether-Ester; PA 6: polyamide-6; PA 66: polyamide-66; SAN: styrene acrylonitrile.

### 3. Definitions

As used herein, the expression “thermoplastic polymers” refers to polymers that can be re-melted after solidification, and remolded.

As used herein, “compatible” refers to thermoplastics that present a good bonding or adhesion to each other when one part is overmolded to a pre-formed part. In the same way, “incompatible” when used in the context the method of the invention refers to thermoplastics that present a poor or weak bonding or adhesion properties to each other when one part is overmolded to a pre-formed part. Compatible resins, when overmolded, preferably show a tensile adhesion of at least at or about 2.5 MPa, more preferably at least at or about 3.0, particularly preferably at least at or about 3.5 MPa, when subjected to a tensile force at 50 mm/min, 23° C., according to ISO 527-1:1993.

As used herein, “compatibilising agents” are additives that may be used to render thermoplastics more “compatible”.

As used herein, “finish” refers to a substance that gives a final texture and/or appearance to the external surface of an article. Examples of finishes are metallic (e.g. silver, chrome, steel or aluminium), a glossy or a mirror-like finish of a paint. “Finishing” refers to the process or technique which allows the modification of the visual and/or tactile aspect of the external surface of an element or article into its final aspect. Painting or metal plating are examples of finishing techniques.

As used herein, “painting” refers to the application of a paint on a support (for example, by brushing, dipping or spraying). Preferred paints are high temperature resistant paints such as epoxy, silicon, and polysiloxane based paints. Painting techniques cover air spray painting and powder coating. Painting of the first thermoplastic part may be carried out over the entire surface of the first part or the overmolding interface area may by left substantially paint free.

### 4. Thermoplastics

According to this invention, typically thermoplastics suitable for Overmolding techniques include:

Styrenic polymers such as ABS (e.g. Cycolac®, Lustran®, Lucky®, Terluran®, Lastilac®, Novodur®, Polyflam®, Polyman®), SAN (styrene acrylonitrile, e.g. Starex®), SBS (styrene-butadiene-styrene, e.g.), ASA (acrylic styrene acrylonitrile e.g. Luran®) and MABS (Methyl Methacrylate Acrylonitrile Butadiene Styrene, e.g. Terlux®);

Polycarbonates such as Apec®, Latilon®, Lexan®, Makrolonv, Panlitev, Plaslube®, Polyman® and Xantar®;

Polysulphones (PSU) such as PES (Polyetether sulfones, e.g. Estaloc®);

Polyphthalamides (PPA) such as Zytel® HTN®, Amodel® and Grivory®;

Polyterephthalate (PET, PETE, PETP) such as Mylar™ and Dacron™;

Thermoplastic polyester such as PBT (PolyButylene Terephthalate polyester, e.g.Crastin®, Ultradur®);

Thermoplastic Elastomer-Ether-Ester (TEEE) such as Hytrel®, Arnitel®;

Thermoplastic polyurethanes (e.g. Estane®);

Thermoplastic elastomers (PTE) (e.g. EstaGrip®);

Thermoplastic vulcanizates (TPV's) such as DuPont ETPV, TFLEX™, Zeotherm®;

Polyamides such as PA6, PA66, PA 6.12 such as glass reinforced (glass fiber) polyamides (e.g. Zytel® PA and Zytel® HTN).

Specific compositions based on PA 6, PA 66, PA 6.12, PPA, TEEE, PBT, PBT/ASA, PET, ABS, PC and PC/ABS are particularly preferred. For underhood applications, the thermoplastic resins should be heat- and chemical-resistant.

Specifically, for high temperature applications such as for automotive articles, PA 6 with 30 wt % glass fiber (for example, for an air intake module and engine cover), PA 66 with 35 wt % glass fiber in rocker covers and PPA with glass fiber are particularly suitable for under hood article manufacture (e.g. ZYTEL® 73G30 HSL BK416, ZYTEL® 70G35 HSLRA4 BK267, ZYTEL® HTN51G35 HSLR BK420 and ZYTEL® 77G33 L BK).

Molding conditions depend on the thermoplastic resin chosen and are specified for each commercially available thermoplastic resin. Important parameters in the molding process are the cylinder temperature profile, the melt temperature (actual temperature of the molten thermoplastic at the time it is injected in the mold cavity), the nozzle temperature, the injection pressure and the drying temperature. For example, for ZYTEL® polyamides the following conditions are recommended: injection pressure (35-140 MPa), mold surface temperatures of 0-95° C., particularly 70° C., cylinder temperature profile for screw machines (rear: 240-300° C.; centre: 230-280° C.; Front: 440-535° C.), melt temperature of 230-310° C. and drying temperatures of 80° C.

Preferably, the thermoplastics for the different parts to be overmolded are compatible to ensure the best adhesion between the two interfaces of the thermoplastic parts. Examples of compatible thermoplastics that show a good bonding adhesion between the surface of the two elements in the process of overmolding according to the invention are presented in Table 1 (crosses show preferred compatibilities) below.

TABLE 1
Compatibility of resins for overmolding (crosses indicate compatible resins)

| Resin | ABS | ASA | EVA | PA6 | PA6.6 | PBT | PET | PC | SAN | PPA |
|---|---|---|---|---|---|---|---|---|---|---|
| ABS | X | X | | | | X | X | X | X | |
| ASA | X | X | X | | | X | X | X | X | |
| EVA | | X | X | | | | | | | |
| PA6 | | | | X | X | | | | | X |
| PA6.6 | | | | X | X | | | | | X |
| PBT | X | X | | | | X | X | X | | |
| PET | X | X | | | | X | X | | | |
| PC | X | X | | | | X | | X | | |
| SAN | X | X | | | | | | | X | |
| PPA | | | | X | X | | | | | X |

Overmolding of different polymer components which are at least partially incompatible may be performed if compatibilising agents are added to either the first or second thermoplastic resin, or both. For example, if the first thermoplastic is a polyamide and the second is a polyolefin, a compatabilising agent such as a carboxyl group-modified polyolefin (e.g. MA-grafted polyethylene) may be added to the first and/or second thermoplastic. The use of compatabilising agents is described, for example, in U.S. Pat. No. 5,154,979, incorporated herein by reference.

Alternatively, compatabilisation between incompatible thermoplastics may be obtained through the finishing agent used on the surface of the first part (i.e. if the finishing agent is compatible with both the first and second thermoplastic it can act as a compatabilising intermediate layer).

The thermoplastic resin for the second part is preferably selected from the above listed thermoplastics. In a preferred embodiment, the thermoplastic resin for the second part may contain a dye or other colouring agent, such as carbon black. Carbon black coloured resins provide a particularly attractive contrast to metallised parts (i.e. when the first part has a metallic finish applied to it).

It is possible to overmold non-compatible thermoplastics if the parts making up the article are so designed that they have surface features at the interface between the two thermoplastic materials which surface features lead to mechanical bonding of the two parts, for example, the first part may be molded to have, for example, ridges, grooves, pits, pores or hooks which will form a mechanical bond with the second thermoplastic part when it is injection molded.

The surface area of the first thermoplastic part which will be in contact with the second resin can be called the interface area. Preferably the finish is not applied over more than 50% of the interface area of the first thermoplastic part, more preferably not more than 40%, particularly preferably not more than 25%. In this way good adhesion between the first and second thermoplastic parts is ensured. If the finish is applied over more than 50% of the interface area, it is preferred that the finish be chosen to be compatible with both the first and second resin.

### 5. Molds

In general, the mold is made of metal, usually either steel or aluminium, preferably steel for the first shot molding. Independent separate molds can be used for the first and for the second part of the article. Preferably, the mold for the second article should be such that the first article is held in place during overmolding of the second part. This can be achieved by vacuum or mechanical undercuts in the mold. The molds are precision-machined to form the features of the desired finished part.

### 6. Overmolding Conditions

Factors that influence adhesion between the two components include thermoplastic compatibility, process temperature, surface contact area and texture, molding sequence, and the design of mechanical interlock systems. In one aspect of the invention, improved adhesion may be achieved if melting flanges, beads or ribs are included on the adhesion sides on the first part, to generate more friction, easier melting on the surface of the first part that will form the interface during overmolding. Such flanges, beads or ribs also decrease distortion during cooling.

In general, the base of a rib should be less than the thickness of the wall to which it is joined and should be tapered in cross section for easy ejection from the mold. Unsupported ribs and beads should be no higher than three times their wall thickness. Ribs and beads on side walls must be perpendicular to the parting line to insure ejection from the mold. Careful placement of ribs and beads is important since they can lead to sink marks and surface discontinuities.

### 7. Compatibilising Agents

Examples of compatibilising agents are polymers including homo or copolyolefin, for example, based on monomers of about 2 to about 8 carbon atoms (e.g. alpha-olefins such as ethylene, propylene, butene-1, hexene-1 and/or octene-1) and wherein the homo or copolyolefin has a functional group thereon.

The functional group may be grafted onto the base of the molecule or polymerized therein.

For example, the functional group is a group capable of reacting with hydroxyl or amino moieties such as acidic acting groups (e.g. carboxyls, acid anhydrides such as maleic acid).

Examples of further compatibilising agents for injection molding are given in U.S. Pat. No. 5,154,979.

### 8. Finishing Compositions

Preferred finishing compositions for the first part are paints, preferably high temperature resistant paints such as epoxy, silicon, or polysiloxane based paints.

The final aspect for the second part may be obtained through either a dye or colouring agent (e.g. carbon black) included in the thermoplastic mixture injected under step (4) or by a final treatment of the entire article.

### 9. Finishing Technique

The finishing step can be selected from the following finishing techniques: air spray painting, chemical vapor deposition (CVD), flame polishing, powder coating, dip coating, thermal spraying, metal plating such as chrome plating (by vacuum deposition or electroplating).

Powder coating is a dry finishing process, using finely ground particles of pigment and resin that are generally electrostatically charged and sprayed onto electrically grounded parts. The charged powder particles adhere to the parts and are held there until melted and fused into a smooth coating in an oven. Before coating, the parts to be coated are first pre-treated similarly to conventional liquid coated parts. The pre-treatment process is normally conducted in series with the coating. There are essentially two common ways of applying powder coating: by electrostatic spray and by fluidized bed powder coating. Other processes that have been developed include flame spraying, spraying with a plasma gun, airless hot spray and coating by electophoretic deposition.

Powder coating includes thermoplastic powder coating and thermoset powder coating. Thermoplastic powder coating is one that melts and flows when heat is applied, but continues to have the same chemical composition once it cools and solidifies.

Thermoplastic powders exhibit excellent chemical resistance, toughness, and flexibility. They are applied mainly by the fluidized bed application technique, in which heated parts are dipped into a vat where the powders are fluidized by air. Such powders are generally applied to a surface that has been preheated to a temperature significantly higher than the melting point of the powder. As a thermoplastic powder material is applied to the hot surface it will melt and “fusion bond” to the surface and then “flow out” into a strong, continuous film. As the film cools it develops its physical properties. Nylon powder coating materials are the most commonly used thermoplastic powders.

Thermosetting powder coatings are based on lower molecular weight solid resins, and melt when exposed to heat. After they flow into a uniform thin layer, however, they chemically crosslink within themselves or with other reactive components to form a reaction product of much higher molecular weight. These newly formed materials are heat stable and, unlike the thermoplastic products after curing, will not soften back to the liquid phase when heated. Thermosetting powders are derived from three generic types of resins: epoxy, polyester and acrylic. From these resin types, several coating systems are derived. Resins used in thermosetting powders can be ground into fine particles necessary for spray application and a thin film finish.

An example of a powder coating technique that may be used in the frame of the invention to paint the first part is sold under the tradename Envex® by DuPont.

Example of powder coatings that may be used in the context of the method according to the present invention are urethane, polyester and acrylic powder coatings.

Metal plating consists in a surface-covering technique in which metal is coated onto a solid surface. Typically, metal plating is used to provide a silver, gold, steel or chrome exterior. Chrome plating, is a finishing treatment utilizing the electrolytic deposition of chromium. Typically, chrome plating forms a layer of a few microns.

### 10. Multi-Component Injection Molded Articles

Multi-component injection molded articles of this invention may be used in the field of visible parts in cars, such as operating elements, instrument panels and ventilation components such as an air intake module.

The multi-component injection molded articles of this invention may have other ergonomic applications of such as grips, handles, tools, gaskets, seals, hoses, bumpers, wheels, air intake manifolds, design covers and rocker covers.

This invention is further illustrated by the following examples which are not intended to limit the scope of the invention in any way.

### EXAMPLE 1

Thermoplastic overmolding of plates with metallic and matte black finish:
(a) Injection molding of the plates to be painted:
ZYTEL® 73G30 HSL BK416 resin (polyamide 6 with 30 wt % glass fiber reinforcement) was injection molded in a slab having dimensions 100×100×2 mm. The injection molding conditions were as follows: cylinder temperature profile was 255° C. for the front, 250° C. for the centre and 245° C. for the rear, the nozzle temperature was 255° C. and the temperature of the melt was maintained at 272° C. The injection pressure was 70 to 90 MPa, the injection time 0.8 to 1.5 sec per cycle (21 cycles in total) and the injection speed was 30 mm/sec.
(b) Metallic finishing of the molded plate:
The slab molded in (a) was painted on one side with a chrome finish paint.
(c) Overmolding a plate on the painted plate:
The slab molded in (a) and painted in (b) was placed in a mold having cavity dimensions 100×100×5 mm (i.e. approximately 3 mm headspace for formation of the second part). The painted slab was placed in the mold so that the painted side faced the walls of the mold cavity, thus leaving the unpainted side to form the interface with the second injection molded thermoplastic resin. ZYTEL® 73G30 HSL BK416 resin was overmolded onto the slab, using a cylinder temperature profile as follows: 295° C. for the front, 295° C. for the centre and 295° C. for the rear, the nozzle temperature was 270-280° C. and the temperature of the melt was maintained at 291-295° C. The injection pressure was 80-85 MPa, injection time was 1.4-1.5 sec per cycle (21 cycles in total) and injection speed was 30 mm/sec.
The resulting overmolded 2-piece plate was chromed on one side, and matte finished on the other, with a clear demarcation between the chromed area and the matte area.

What is claimed is:

1. A method for making a thermoplastic article having at least two different finishes on different zones of its surface, the method comprising the following steps:
(1) injection molding a first thermoplastic part of the article;
(2) applying a surface finish to the first part;
(3) placing the first part in an injection molding mold; and
(4) overmolding a second thermoplastic part of the article in such a way as to form an interface between the first part and the second part, where adhesion between the first part and the second part is achieved at the interface.

2. A method according to claim 1 wherein the injection molding of said first thermoplastic part of the article comprises the steps of:
(a) selecting a first thermoplastic resin;
(b) melting the first thermoplastic resin;
(c) injection molding of the heated first thermoplastic resin; and
(d) cooling the injection molded resin to room temperature.

3. A method according to claim 1, wherein said first and second thermoplastic resins are selected independently from styrenic polymers, Polycarbonates, Polyphthalamides, Polyterephthalates, Thermoplastic polyesters, Thermoplastic Elastomer-Ether-Esters and Polyamides.

4. A method according to claim 1, wherein said first and second thermoplastic resins are selected independently from Polyamides and Polyterephthalates.

5. A method according to claim 4, wherein said first and second thermoplastic resins are glass reinforced.

6. A method according to claim 1, wherein said first and second thermoplastic resins are selected independently from polyamide 6 with glass fiber, polyamide 66 with glass fiber, and Polyphthalamide with glass fiber.

7. A method according to claim 1, wherein the finish applied to the surface of the first thermoplastic part is applied by a technique selected from powder coating and air spray painting.

8. A method according to claim 1, wherein the finish applied to the surface of the first thermoplastic part is a high temperature resistant paint.

9. A method according to claim 1, wherein the finish applied to the surface of the first thermoplastic part is a metallic finish.

10. A method according to claim 1, wherein the finish is applied to the surface of the first thermoplastic followed by a drying step.

11. A method according to claim 1, wherein the overmolding of said second thermoplastic part of the article comprises the steps of:
(a′) selecting a second thermoplastic resin;
(b′) optionally adding a compatibilising agent to the second thermoplastic resin selected under (a′);
(c′) melting the second thermoplastic resin; and
(d′) overmolding of the heated second thermoplastic resin on the first thermoplastic part.

12. A method according to claim 1, wherein the second thermoplastic resin is selected from Polyamides and Polyterephthalates.

13. A method according to claim 12, wherein the second thermoplastic resin is glass reinforced.

14. A method according to claim 1, wherein the second thermoplastic resin is selected from polyamide 6 with glass fiber, polyamide 66 with glass fiber, and Polyphthalamide with glass fiber.

15. A method according to claim 1, wherein the second thermoplastic resin contains carbon black.

16. A method according to claim 1, wherein the surface finish is applied to the first part such that it is applied to less than at or about 50% of the interface area.

17. A thermoplastic article of two or more components with a different surface finish on different surface zones, produced by the method according to claim 1.

18. A thermoplastic article according to claim 17, wherein at least one surface zone has a metallic finish.

19. A thermoplastic article according to claim 17, which is an automobile part.

20. The thermoplastic article of claim 17, which is an air intake manifold with matte black finish on some surface zones and metallic finish on other surface zones.
